(19) United States
(12) Patent Application Publication
(10) Pub. No.: US 2024/0161027 A1
(43) Pub. Date: May 16, 2024

(54) OPPORTUNITY CONTRIBUTION ALLOCATION BASED ON ACTIVITIES AND TASKS

(71) Applicant: INTERNATIONAL BUSINESS MACHINES CORPORATION, Armonk, NY (US)

(72) Inventors: Zachary A. Silverstein, Georgetown, TX (US); Melanie Dauber, Oceanside, NY (US); Jacob Ryan Jepperson, St. Paul, MN (US); Jeremy R. Fox, Georgetown, TX (US); Spencer Thomas Reynolds, Austin, TX (US)

(21) Appl. No.: 17/985,251

(22) Filed: Nov. 11, 2022

(51) Int. Cl. G06Q 10/06; G06Q 10/10

(52) U.S. Cl. CPC G06Q 10/063114; G06Q 10/06398; G06Q 10/1091

(57) ABSTRACT

A method includes: receiving, by a processor set, user input defining parameters of a project; receiving, by the processor set, opt-in input from team members defined in the parameters of the project; retrieving, by the processor set and from electronic data sources, data that corresponds to performance of tasks of the project by each of the team members; generating, by the processor set and based on the retrieved data, a respective contribution score of each of the team members; generating, by the processor set and based on the respective contribution scores of each of the team members, a respective allocation score of each of the team members; allocating, by the processor set, an award to the team members based on the respective allocation scores of each of the team members.

### BACKGROUND

Aspects of the present invention relate generally to collaborative work in computing environments and, more particularly, to computer-based opportunity contribution allocation based on activities and tasks.

Projects are often performed by groups of people collaborating with each other. A project may be divided into tasks, and different members of a team may work individually, or together in smaller groups, to complete one or more of the tasks. Awards may be based on the amount that a team member contributed to the completion of the project.

### SUMMARY

In a first aspect of the invention, there is a computer-implemented method including: receiving, by a processor set, user input defining parameters of a project; receiving, by the processor set, opt-in input from team members defined in the parameters of the project; retrieving, by the processor set and from electronic data sources, data that corresponds to performance of tasks of the project by each of the team members; generating, by the processor set and based on the retrieved data, a respective contribution score of each of the team members; generating, by the processor set and based on the respective contribution scores of each of the team members, a respective allocation score of each of the team members; allocating, by the processor set, an award to the team members based on the respective allocation scores of each of the team members.

In another aspect of the invention, there is a computer program product including one or more computer readable storage media having program instructions collectively stored on the one or more computer readable storage media. The program instructions are executable to: receive user input defining parameters of a project; receive opt-in input from team members defined in the parameters of the project; retrieve, from electronic data sources, data that corresponds to performance of tasks of the project by each of the team members; generate, based on the retrieved data, a respective contribution score of each of the team members; generate, based on the respective contribution scores of each of the team members, a respective allocation score of each of the team members; allocate an award to the team members based on the respective allocation scores of each of the team members.

In another aspect of the invention, there is system including a processor set, one or more computer readable storage media, and program instructions collectively stored on the one or more computer readable storage media. The program instructions are executable to: receive user input defining parameters of a project; receive opt-in input from team members defined in the parameters of the project; retrieve, from electronic data sources, data that corresponds to performance of tasks of the project by each of the team members; generate, based on the retrieved data, a respective contribution score of each of the team members, wherein the contribution score of a respective one of the team members is based on quantity of contributions to the project by the respective one of the team members and quality of contributions to the project by the respective one of the team members; generate, based on the respective contribution scores of each of the team members, a respective allocation score of each of the team members; allocate an award to the team members based on the respective allocation scores of each of the team members.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 shows a diagram of an exemplary method in accordance with aspects of the invention.

FIG. 4 shows a flowchart of an exemplary method in accordance with aspects of the invention.

### DETAILED DESCRIPTION

Aspects of the present invention relate generally to collaborative work in computing environments and, more particularly, to computer-based opportunity contribution allocation based on activities and tasks. Implementations of the invention use computer-based systems to monitor individual team members' contributions to tasks performed in the act of completing a team project. Based on the monitoring, implementations determine a contribution allocation for each team member for the project. In this manner, implementations of the invention provide an accurate accounting of who contributed what to the project.

Often times in team-based projects, the determination of which team members contributed what and how much to completing the project is subjective based on the perception of people outside the team. This can result in some team members going unrecognized for their efforts, and other team members gaining credit where it was not due. For example, a first team member may have performed 90% of the work for a deliverable, and a second team member may have performed 10% of the work for the same deliverable. If the team members are rewarded equally for completing the project (for example if they split a commission or other award equally), then this results in the first team member being undervalued relative to their effort and the second team member being overvalued relative to their effort. This can result in dissatisfied team members and habitual patterns within companies incentivizing bad behavior.

Aspects of the invention address this problem by providing a computer-based system that accurately determines how much individual team members contribute to a project based on monitoring application usage and electronic communication related to the project. By quantifying team members' quantity and quality of contribution based on application usage and electronic communications, implementations of the invention provide a technical solution to the problem of inaccurate determination of which team members contributed what and how much to completing the project. Implementations perform aspects of the monitoring and quantifying using techniques that are machine based and have no pre-Internet analogue, including determining sentiment of electronic communications using natural language processing and obtaining data from data sources using application programming interfaces, software application plug-ins, and software application add-ons.

As will be apparent from the description herein, implementations of the invention provide a method to identify and allocate project task completion to appropriate performers, the method comprising: identifying one or more tasks associated with a project/goal; tracking a completion of the one or more tasks and completion of the project, wherein the tracking includes monitoring integration with collaboration software to isolate tasks and participation and track user fulfillment of requirements, determining a scope for each task including a predicted completion time, and prioritizing each of the tasks based on weighed importance and contribution size taking into account factors such as urgency, time spent, content delivered, etc.; quantifying, for each task, a contribution for each participant, wherein the quantification is based on the determined scope and the monitoring of the task completion; allocating, based on the monitoring, a completion score for each participant of each task, wherein the completion score represents the contribution toward completion of the tasks including the weighting features; aggregating each allocation for each task to an overall completion score; and assigning, based on the overall completion score, an award to the participants in the project. The facilitation and request may be aligned against internal and external stakeholders and role seniority. The weighting for names assigned to tasks in the tracking program may be greatly reduced to focus on the contribution of others. The invention module may utilize natural language processing (NLP) to analyze communications to identify tasks completed via email, short message service (SMS), instant message (IM), online meetings, calendars (e.g., vacation, etc.), and the like to determine the overall contribution of the parties to the completion of the task.

In another aspect there is a method that monitors communication between parties over text and audio and utilizes NLP to dynamically extract information used to determine which team members contributed to completing tasks and the an importance of the tasks. In embodiments, the code that implements aspects of the method integrates with collaboration software to isolate tasks and participation, and to track user fulfilment of requirements related to the tasks. The priority of the tasks may be captured and weighted based on importance and contribution size, taking into account factors such as urgency, time spent, content delivered, etc. The method may track tasks requested by a client or customer, and the completion of such requested tasks by an individual team member. The facilitation and request of such tasks may be aligned against internal and external stakeholders role and seniority. The method may automatically integrate feedback and contributions into a reward and feedback system. The method may utilize NLP in communications to identify tasks completed via email, SMS, IM, etc.

It should be understood that, to the extent implementations of the invention collect, store, or employ personal information provided by or obtained from individuals (for example, electronic communications, application usage data, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as contribution allocation code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

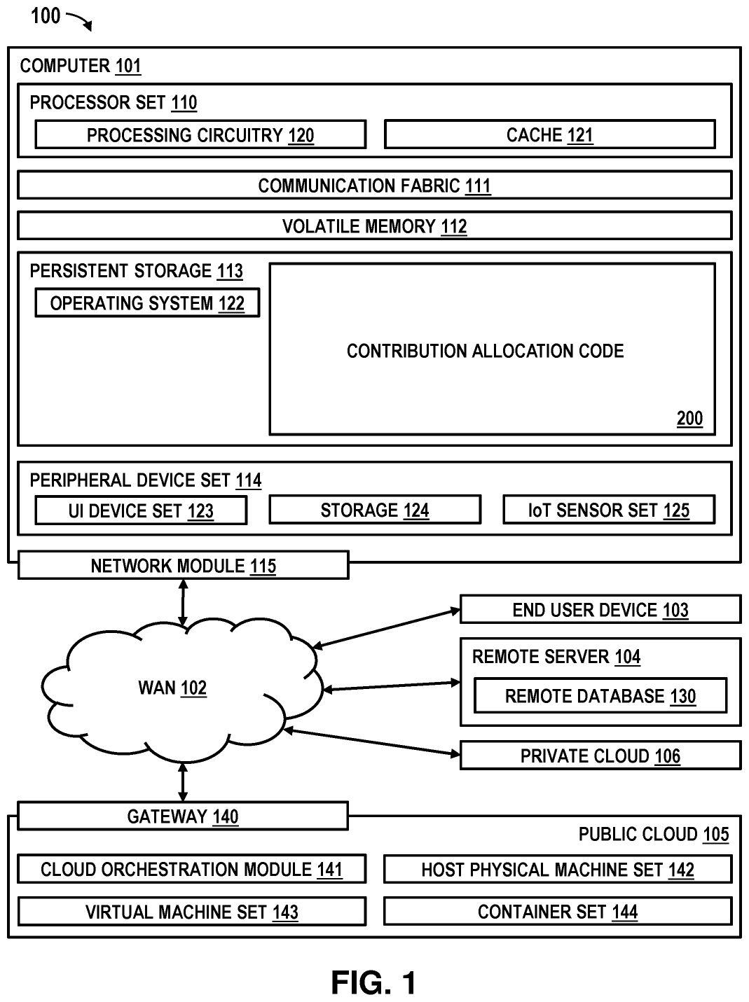

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

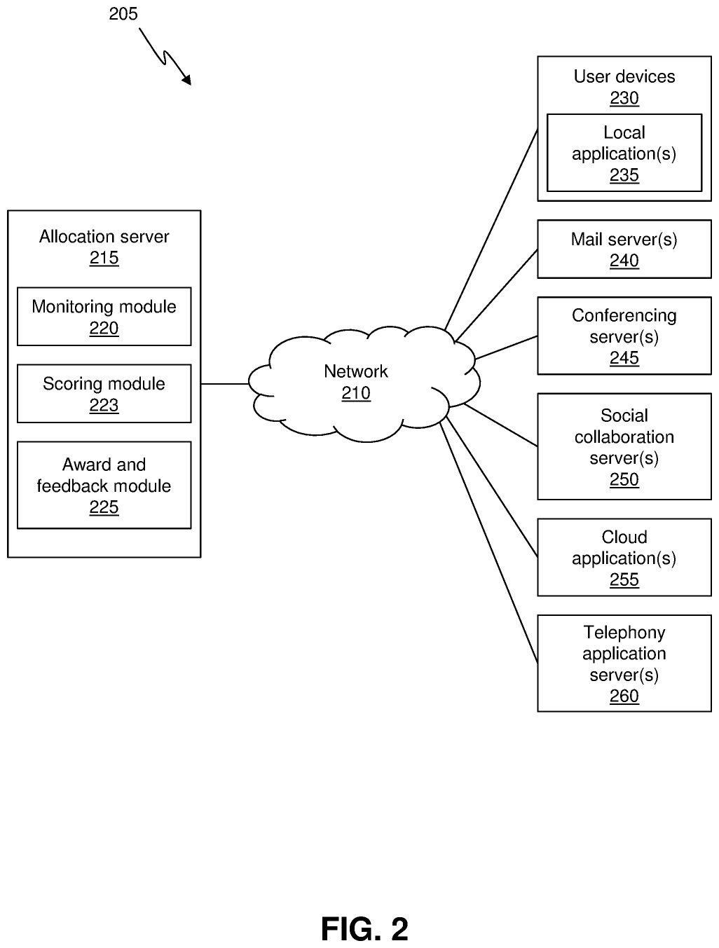

FIG. 2 shows a block diagram of an exemplary environment 205 in accordance with aspects of the invention. In embodiments, the environment includes a network 210 that provides communication between an allocation server 215 and user devices 230 and data sources such as mail servers 240, conferencing servers 245, social collaboration servers 250, cloud applications 255, and telephony application servers 260.

The allocation server 215 of FIG. 2 may correspond to the computer 101 of FIG. 1. In one example, the allocation server 215 is implemented using one or more instances of computer 101 of FIG. 1. In another example, the allocation server 215 is implemented using one or more virtual machines or containers running on one or more instances of computer 101 of FIG. 1. The network 210 of FIG. 2 may correspond to the WAN 102 of FIG. 1. The user devices 230 of FIG. 2 may correspond to instances of end user device 103 of FIG. 1. Each of the mail servers 240, conferencing servers 245, social collaboration servers 250, cloud applications 255, and telephony application servers 260 may correspond to or be implemented using instances of remote server 104 and/or public cloud 105 and/or private cloud 106 of FIG. 1.

In embodiments, the allocation server 215 comprises monitoring module 220, scoring module 223, and award and feedback module 225, each of which may comprise one or more modules of the code of block 200 of FIG. 1. These modules of the code of block 200 are executable by the processing circuitry 120 of FIG. 1 to perform the inventive methods as described herein. The allocation server 215 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the monitoring module 220 is configured to monitor electronic data sources such as user devices 230, mail servers 240, conferencing servers 245, social collaboration servers 250, cloud applications 255, and telephony application servers 260 for the purpose of retrieving information related to the performance of tasks of a project. In accordance with aspects of the invention, the scoring module 223 is configured to generate contribution scores for team members based on the data retrieved by the monitoring module 220, where the score for a particular team member represents a quantification of a contribution that team member made to a project. In accordance with aspects of the invention, the award and feedback module 225 is configured to determine an allocation of one or more awards based on the contribution scores of the team members. In embodiments, the award and feedback module 225 is further configured to receive feedback from team members and recalculate the scoring and allocation based on the feedback.

Referring now to the monitoring module 220, in embodiments the monitoring module 220 monitors and retrieves data from local applications 235 running on user devices 230 to determine how much time a team member spends using the local application 235 to create content for a task of a project. The monitoring module 220 may also monitor local applications 235 running on user devices 230 to determine how much task-related content a team member creates using the local application 235. For example, the monitoring module 220 may retrieve data from a word processing application running on a user device 230 to determine how much time each team member spent using the word processing application to create portions of a document (e.g., such as a request for proposals), and also how much content each team member created (e.g., by word count and/or page count in the word processing application). The word processing application is only an example, and other types of applications may be monitored, such as spreadsheet applications (e.g., for creating spreadsheet content of the project), presentation applications (e.g., for creating presentation content of the project), and integrated development environment (IDE) applications (e.g., for creating code content of the project). In embodiments, the monitoring module 220 is integrated with each respective local application 235 using a respective plug-in or add-on that is specific to the monitoring module 220 (e.g., used only by the monitoring module 220), wherein the plug-in or add-on comprises specialized code that permits the monitoring module 220 to access the data of the local application 235 for performing the specialized monitoring described herein. Each different local application 235 may have a different plug-in or add-on that is designed specifically for the monitoring module 220 for this purpose.

In another example, the monitoring module 220 monitors and retrieves data from mail servers 240 to determine quantity, timeliness, and sentiment of email communications by or about team members associated with the project. For example, the monitoring module 220 may monitor and retrieve data from mail servers 240 to determine how many project-related emails a team member sends to other team members and/or to a client. For example, the monitoring module 220 may determine from mail server 240 data that one team member sent three emails related to the project, and another team member sent thirty emails about the same project. In another example, the monitoring module 220 monitors and retrieves data from mail servers 240 to determine the timeliness of team members in responding to emails about the project. For example, the monitoring module 220 may determine from mail server 240 data that one team member responds to project-related emails within one business day on average, and that another team member responds to project-related emails within three business days on average. In another example, the monitoring module 220 monitors and retrieves data from mail servers 240 to determine sentiment of project-related emails about team members. For example, the monitoring module 220 may analyze text of emails using natural language processing and sentiment analysis to determine that a client or other team members have a positive or negative sentiment about a particular team member's work related to the project. In all instances of email monitoring (e.g., quantity, timeliness, and sentiment), the monitoring module 220 may use natural language processing to analyze the text of an email (e.g., text contained in the subject line, email body, or attachments) to determine whether an email is related to a task of a project, e.g., by comparing text of the email to keywords associated with the task or project. In embodiments, the monitoring module 220 accesses data in the mail servers 240 using an application programming interface (API) that is specific to the monitoring module 220 (e.g., used only by the monitoring module 220) and that is configured to permit the monitoring module 220 to access the data of the mail servers 240 for performing the specialized monitoring described herein.

In another example, the monitoring module 220 monitors and retrieves data from conferencing servers 245 to determine quantity and sentiment of video conference communications by or about team members associated with the project. For example, the monitoring module 220 may monitor and retrieve data from conferencing servers 245 to determine: how much time a team member spends in attendance of project-related video conferences; how much time a team member spends talking during project-related video conferences; how much time a team member shares their screen during project-related video conferences; and how much time a team member spends on mute during project-related video conferences; and a sentiment of other users' comments to or about the team member during project-related video conferences. The monitoring module 220 may determine time spent in attendance, time spent talking, time spent screen sharing, and time spent on mute using data available from the conferencing servers 245. The monitoring module 220 may determine sentiment by converting speech (audio) of the video conference to text and then analyzing the text using natural language processing and sentiment analysis to determine that a client or other team members have a positive or negative sentiment about a particular team member during the video conference. In all instances of video conference monitoring (e.g., quantity and sentiment), the monitoring module 220 may use natural language processing to analyze the content of the videoconference (e.g., text obtained using speech to text conversion) to determine whether the videoconference is related to a task of a project, e.g., by comparing text of the videoconference to keywords associated with the task or project. In embodiments, the monitoring module 220 accesses data in the conferencing servers 245 using an application programming interface (API) that is specific to the monitoring module 220 (e.g., used only by the monitoring module 220) and that is configured to permit the monitoring module 220 to access the data of the conferencing servers 245 for performing the specialized monitoring described herein.

In another example, the monitoring module 220 monitors and retrieves data from social collaboration servers 250 to determine sentiment of social media communications by or about team members associated with the project. For example, the monitoring module 220 monitors data obtained from social collaboration servers 250 to determine sentiment of project-related social media communications to or about team members. For example, the monitoring module 220 may analyze text of social media communications using natural language processing and sentiment analysis to determine that a client or other team member has a positive or negative sentiment about a particular team member's work related to the project. The monitoring module 220 may use natural language processing to analyze the text of a social media communication (e.g., text contained in the social media communication) to determine whether the social media communication is related to a task of a project, e.g., by comparing text of the social media communication to keywords associated with the task or project. In embodiments, the monitoring module 220 accesses data in the social collaboration servers 250 using an application programming interface (API) that is specific to the monitoring module 220 (e.g., used only by the monitoring module 220) and that is configured to permit the monitoring module 220 to access the data of the social collaboration servers 250 for performing the specialized monitoring described herein.

In another example, the monitoring module 220 monitors and retrieves data from cloud applications 255 to determine how much time a team member spends using the cloud applications 255 to create content for a task of a project and/or how much task-related content a team member creates using the cloud applications 255. As described herein, cloud applications 255 comprise software applications that are provided by a cloud service provider to a user of user device 230. The cloud applications 255 are run on cloud servers as opposed to local applications 235 that run on the user device 230. For example, the monitoring module 220 may monitor and retrieve data from a word processing application provided via a cloud service provider to determine how much time each team member spent using the word processing application to create portions of a document (e.g., such as a request for proposals), and also how much content each team member created (e.g., by word count and/or page count in the word processing application). The word processing application is only an example, and other types of cloud applications may be monitored, such as spreadsheet applications (e.g., for creating spreadsheet content of the project), presentation applications (e.g., for creating presentation content of the project), and integrated development environment (IDE) applications (e.g., for creating code content of the project). In embodiments, the monitoring module 220 accesses data of the cloud applications 255 using an application programming interface (API) that is specific to the monitoring module 220 (e.g., used only by the monitoring module 220) and that is configured to permit the monitoring module 220 to access the data of the cloud applications 255 for performing the specialized monitoring described herein.

In another example, the monitoring module 220 monitors and retrieves data from telephony application servers 260 to determine sentiment of telephone communications by or about team members associated with the project. For example, the monitoring module 220 monitors data obtained from telephony application servers 260 to determine sentiment of project-related telephone conversations to or about team members. The monitoring module 220 may determine sentiment by converting speech (audio) of the telephone communications to text and then analyzing the text using natural language processing and sentiment analysis to determine that a client or other team members have a positive or negative sentiment about a particular team member during the telephone communications. The monitoring module 220 may use natural language processing to analyze the content of a telephone communication (e.g., text obtained using speech to text conversion) to determine whether the telephone communication is related to a task of a project, e.g., by comparing text of the telephone communication to keywords associated with the task or project. In embodiments, the monitoring module 220 accesses data in the telephony application servers 260 using an application programming interface (API) that is specific to the monitoring module 220 (e.g., used only by the monitoring module 220) and that is configured to permit the monitoring module 220 to access the data of the telephony application servers 260 for performing the specialized monitoring described herein.

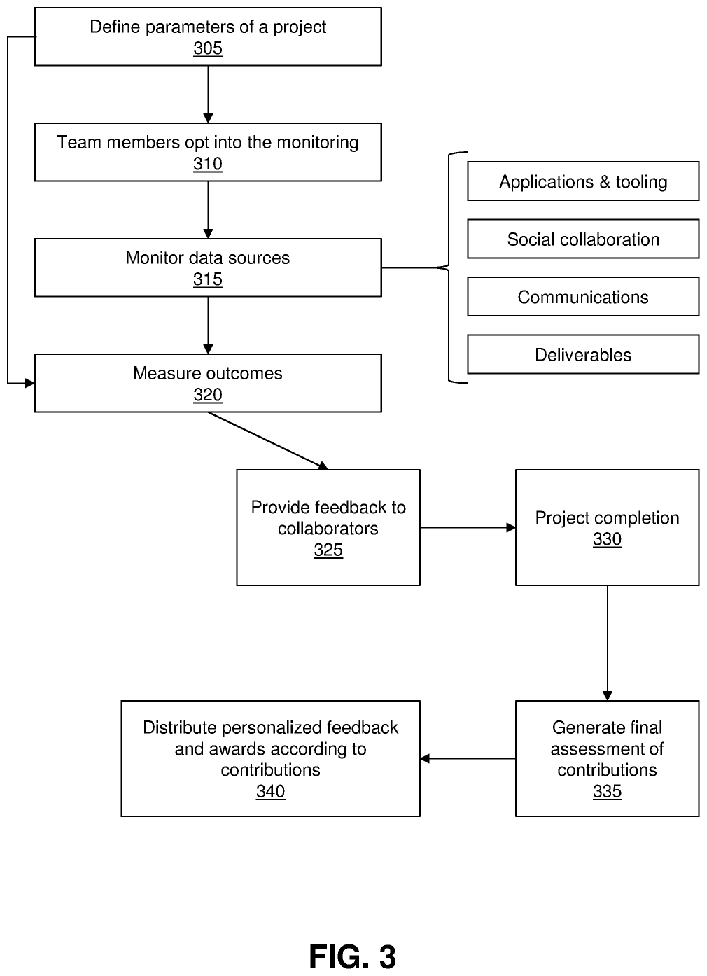

FIG. 3 shows a diagram of an exemplary method in accordance with aspects of the invention. Steps of the method may be carried out in the environment of FIG. 2 and are described with reference to elements depicted in FIG. 2.

Step 305 comprises defining parameters of a project. In embodiments, the allocation server 215 receives user input that defines: team members for a project; customer or client of the project; deliverables of the project; tasks of the project; which data sources will be monitored (e.g., data sources 230, 240, 245, 250, 255, 260 of FIG. 2); and how the data from the data sources will be assessed for determining contribution scores of team members (e.g., scoring rules). This data is saved and provides an explainable scope of the project to the team members so that they can understand how, when, and why they are being monitored and assessed for this particular project. In embodiments, the data defining the deliverables and tasks includes, or is tagged with, keywords that are used for comparing to data from the data sources (e.g., emails, content of the videoconference, text of a social media communication, telephone conversations, etc.) to determine if the data is relevant to the project, e.g., as described above with respect to FIG. 2.

Step 310 comprises the team members opting into monitoring for the project defined at step 305. In embodiments, the allocation server 215 presents the team members identified in the parameters of a project (at step 305) with an explanation of how, when, and why they are being monitored and assessed for this particular project. In embodiments, the allocation server 215 presents each team member with an option to opt into or opt out of monitoring for the project. In embodiments, the allocation server 215 receives input from each of the team members regarding their choice to opt in or opt out. In accordance with aspects of the invention, the allocation server 215 only monitors the data of team members that opt in at step 310, and the allocation server 215 does not monitor the data of team members that opt out at step 310. In this manner, implementations of the invention provide users with a mechanism to opt into the tracking of their data, contributions, conversations, etc.

Step 315 comprises the allocation server 215 monitoring and retrieving data from data sources such as the data sources 230, 240, 245, 250, 255, 260 of FIG. 2. In embodiments, the system monitors a vast array of data, tooling, relationship management, data, metadata, and other evolving topics as a project, DevOps business, or other context related area evolves over time. Examples of data sources include but are not limited to applications and tooling, social collaboration, communications, and deliverables. Applications and tooling monitoring may include monitoring data from tools, applications, and other software generating reports, such as local applications 235 and cloud applications 255 of FIG. 2, for example. Social collaboration monitoring may include utilizing NLP to determine positive and negative contributions and weighting of the overall quality and quantity of the social interactions and engagement between a team member and the client or customer. Social collaboration monitoring may involve determining involvement and the quantity thereof, and may include monitoring texting and instant messaging data from social collaboration servers 250 of FIG. 2. Communications monitoring may include measuring the various types of communications with the client or customer, as well as with other team members. Communications monitoring may include monitoring telephone calls, e-mail, posting, conversations, meetings, chat, demos, interactive working sessions, etc., and may include monitoring data from mail servers 240, conferencing servers 245, and telephony application servers 260. Deliverables monitoring may include tracking quantifiable work product such as documents delivered to a client or customer. Deliverables monitoring may include monitoring data from email servers 240 to determine when a deliverable is provided to the client or customer, and analyzing data from local applications 235 and/or cloud applications 255 to determine how much the deliverable was created by each team member.

Step 320 comprises measuring outcomes of the project as defined in the initial scope of the project (e.g., at step 305). In embodiments, the scoring module 223 generates a quantifiable measurement metric for all the various components that are being tracked for tracking criteria. In embodiments, the scoring module 223 generates a quantifiable outcome score for each tracking item and produces a larger aggregate score that encompasses the entire scope for the aggregate contribution score for one single team member. In embodiments, the scoring module 223 generates quantifiable measurements for weighting factors including time spent, quality produced, and overall percentage of quantifiable work products in relation to the larger team aggregate goal.

Step 325 comprises providing feedback to team members on their actual contribution level as measured by outcomes (e.g., at step 320). In embodiments, the award and feedback module 225 provides each team member with an individualized report that indicates that team member's determined contribution to the project. Step 325 may be performed at intervals prior to project completion (at step 330) so that team members can see their contribution while the project is still ongoing. In this manner, the team members understand where they fit into the overall larger piece of the puzzle, pertaining to their relative contributions across a host of team members. In embodiments, this reporting shows the full scope of various items being tracked with clear and concise tracking and transparency. In embodiments, this reporting lets users understand where their contributions may be lacking allows them to better themself through iterative feedback loops during the project, support timeline, etc.

Step 335 comprises generating a final assessment of contributions of the team members. In embodiments, within the interval timeline and when the assessment period has completed, the award and feedback module 225 generates a finalized assessment of the respective contributions of all team members to completion of the project that was defined at step 305.

Step 340 comprises distributing personalized feedback and awards according to the contributions generated at step 335. In embodiments, the award and feedback module 225 provides each team member with an individualized report that indicates that team member's determined contribution to the project. In embodiments, the award and feedback module 225 also determines allocations of an award for the project for each team member based on the contributions of each team member. This debriefing feedback is useful for team members to understand how, why, and when they can change their actions to achieve a different contribution score in future projects. This debriefing feedback is also useful for team members to identify synergistic opportunities that can be leveraged in future projects.

An exemplary use case will now be described to illustrate various aspects of implementations of the invention. Melanie, Mark, and Nancy are a team working on a sales opportunity for client XYZ. Melanie is the technical seller responsible for progressing the technical win. Mark is the seller responsible for contracts, account management, and closing the deal. Nancy is the product subject matter expert responsible for deep product expertise. The team works externally with client XYZ typically through: video conversations/demonstrations; emails; telephone calls; text messages; on-site briefings; collaborative documents/folders; shared assets in an Internet hosting service for software development and version control; quotes and pricing applications. The team works internally with the above methods and additionally with: a customer engagement platform for sales and service; sizing tools; support software; and a messaging application. Throughout the sales opportunity Melanie works both internally and externally on: a request for proposal (RFP); demonstrations; proof of technology and proof of concepts; architectural briefings, modernization workshops, and sizing proposals for infrastructure and licensing. Nancy assists on these assets as a deep technical subject matter expert. Nancy joins multiple client conversations, is an active participant in the client conversations, makes updates to documents stored in shared folders, logs her calls into the customer engagement platform for sales and service, etc. On the other hand, Mark does not make updates to the RFP, joins only a few calls with the customer and sits on mute without speaking during the calls, and is left off of the majority of communications with the customer. In accordance with aspects of the invention, the allocation server 215 monitors Melanie, Nancy, and Mark's activities through the various data sources and generates recommended percentages to the commission pools of how the earnings should be split. In embodiments, the system uses a feedback loop to iteratively improve and take into consideration manual updates that may not have been captured (vacation, paid time off, time zones, etc.). Additional embodiments utilize work and contribution type weighting to account for consideration of the type of work and its significance to a project. For example, thought leadership or advisory contributions to help complete a task of a project are considered even if that individual did not complete a deliverable. In another example, if someone was consulted that resulted in a problem being solved that helped close a deal, that contribution is considered with higher weight when determining the contribution assessments.

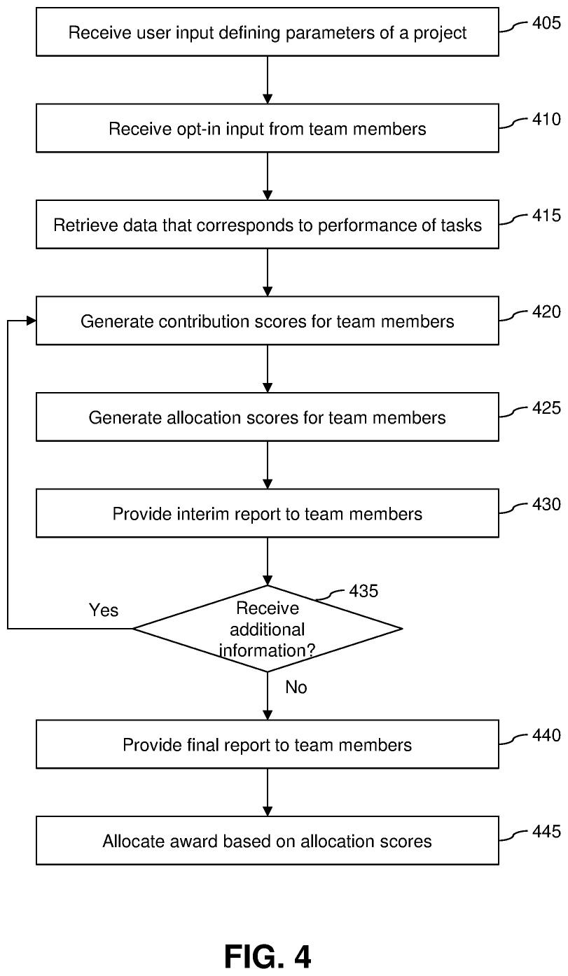

FIG. 4 shows a flowchart of an exemplary method in accordance with aspects of the present invention. Steps of the method may be carried out in the environment of FIG. 2 and are described with reference to elements depicted in FIG. 2.

At step 405, the system receives user input defining parameters of a project. In embodiments, and as described with respect to FIGS. 2 and 3, the allocation server 215 receives user input defining parameters of a project. The input may be provided via one of the user devices 230, e.g., by a project manager, team leader, administrator, etc. The input may include data that defines: the members of the team (e.g., name, identification number, etc.); the data sources that will be monitored (e.g., specific instances of data sources 235, 240, 245, 250, 255, 260); and scoring rules (as described herein). In embodiments, the system saves the data defining the parameters in manner such that the parameters may be accessed and viewed by the team members.

In accordance with aspects of the invention, the scoring rules define how different contributions are weighted in determining a contribution score of a team member for this project. The scoring rules may include scoring rules for a quantity of contribution by a team member and for a quality of contribution by a team member. Examples of scoring rules are provided in the following description. These scoring rules are not limiting, and different scoring rules may be defined in the parameters and used in determining the contribution score of each team member. An exemplary scoring rule adds 1 point to a team member's contribution score for each hour spent by the team member using a local application 235 or a cloud application 255 to create content for the project. Content related to the project may be content that is saved to a shared storage dedicated to the project or content that the team member indicates is related to the project. Another exemplary scoring rule adds 1 point to a team member's contribution score for each percent of a deliverable (e.g., document, spreadsheet, presentation, code, etc.) that was created by this the team member. Another exemplary scoring rule adds 10 points to a team member's contribution score when the team member responds to at least 90% of project related emails within one business day. Another exemplary scoring rule adds 10 points to a team member's contribution score when the team member responds to at least 90% of project related text messages or instant messages within one hour. Another exemplary scoring rule adds 1 point to a team member's contribution score for each minute that this team member spent speaking during a project related video conference. Another exemplary scoring rule adds 2 points to a team member's contribution score for each minute that this team member was concurrently speaking and sharing their screen during a project related video conference. Another exemplary scoring rule adds 10 points to a team member's contribution score when a project related communication, from another team member, has a positive sentiment about the team member. Another exemplary scoring rule adds 20 points to a team member's contribution score when a project related communication, from an internal stakeholder that is not a team member, has a positive sentiment about the team member. Another exemplary scoring rule adds 30 points to a team member's contribution score when a project related communication, from an external stakeholder that is not a team member (e.g., a client or customer), has a positive sentiment about the team member. Another exemplary scoring rule subtracts 20 points from a team member's contribution score when a project related communication, from an external stakeholder that is not a team member (e.g., a client or customer), has a negative sentiment about the team member. As can be seen from these examples, different scoring weights may be defined based on the role of a stakeholder (e.g., a team member, an internal stakeholder that is not a team member, an external stakeholder that is not a team member, etc.).

At step 410, the system receives opt-in input from the team members defined in the parameters of step 405. In embodiments, and as described with respect to FIGS. 2 and 3, the allocation server 215 receives user input from each of the team members, the user input being either an opt in or an opt out for monitoring for this project.

At step 415, the system retrieves data that corresponds to performance of tasks of the project by each of the team members. In embodiments, and as described with respect to FIGS. 2 and 3, the monitoring module 220 obtains data from the data sources defined in the parameters, the data comprising data that is related to the performance of tasks of the project. As described herein, the data can include content that is created by team members, data about how the content was created (e.g., actions performed and time spent using applications, tools, etc.), and communications about the project.

At step 420, the system generates contribution scores for the team members using the data obtained at step 415. In embodiments, and as described with respect to FIGS. 2 and 3, the scoring module 223 generates a respective contribution score for each team member by applying the scoring rules defined in the parameters (from step 405) to the retrieved data (from step 415). In one example, a team member's contribution score is a sum of all points added and subtracted according to the scoring rules, examples of which are described above.

In embodiments, and as described with respect to FIGS. 2 and 3, the contribution score of each of the team members is based on quantity of contributions to the project by the respective one of the team members and quality of contributions to the project by the respective one of the team members. In embodiments, one or more scoring rules may be defined (e.g., by an administrator, team leader, etc.) such that the quantity of contributions is determined based on the amount of content created by the respective one of the team members using content creating applications, such as documents, spreadsheets, presentations, code created using the local applications 235 and/or cloud applications 255. In embodiments, one or more scoring rules may be defined (e.g., by an administrator, team leader, etc.) such that the quality of contributions is determined based on determined sentiment of project-related communications to or about the team member, such communications made via mail servers 240, conferencing servers 245, social collaboration servers 250, and telephony application servers 260. In embodiments, and as described herein, the sentiment of the communications is determined by analyzing the communications using natural language processing and sentiment analysis.

At step 425, the system generates allocation scores for the team members using the contribution scores from step 420. In embodiments, and as described with respect to FIGS. 2 and 3, the scoring module 223 determines an allocation score for a team member according to a predefined allocation formula. One example of an allocation formula is the team member allocation score equals the team member contribution score divided by a sum of the contribution scores of all team members.

At step 430, the system provides an interim report to each of the team members. In embodiments, the award and feedback module 225 generates an individualized report for each of the team members. In one example, the report for a particular one of the team members includes: the contribution score of this team member; the allocation score of this team member; and an explanation of how the contribution score of this team member was calculated (e.g., respective line items for each applicable scoring rule). In an example, the explanation can include an indication of data and how the data was scored using the scoring rules. In embodiments, the report is provided electronically, e.g., via the user devices 230.

At step 435, the system permits the team members to provide additional information about their contributions to the project. In embodiments, and as described with respect to FIGS. 2 and 3, a team member may be of the opinion that the retrieved data (from step 415) does not accurately reflect this team member's actual contribution to the project. In embodiments, the team member may provide additional information to the system (e.g., uploading content that was created for the project but not included in the retrieved data, uploading copies of electronic communications that are not included in the retrieved data, etc.).

In the event that the system receives additional information at step 435, then the process returns to step 420 where the scoring module 223 re-determines the contribution scores of all the team members based on the retrieved data (from step 415) and the additional information (from step 435). The process then proceeds again to step 425 where the scoring module 223 re-determines the allocation scores of all the team members based on the re-determined contribution scores. The process then proceeds again to step 430 where the award and feedback module 225 generates updated interim reports based on the re-determined contribution scores and allocation scores. This loop repeats until no additional information is received at step 435. The system may set a time limit for team members to provide additional information at step 435 and may proceed to step 440 when no additional information has been provided in the time limit.

At step 440, the system provides a final report to each of the team members. In embodiments, the award and feedback module 225 generates an individualized final report for each of the team members. In one example, the final report for a particular one of the team members includes: the contribution score of this team member; the allocation score of this team member; and an explanation of how the contribution score of this team member was calculated,

At step 445, the system allocates an award to the team members based on the allocation scores of the team members. In embodiments, the scoring module 223 determines an allocation of the award amongst the team members according to a predefined award allocation formula that utilizes the allocation scores. One example of an award allocation formula is the award is proportionally allocated to the team members based on the team members allocation scores. In this example, a team member with an allocation score of 55% receives 55% of the award, a team member with an allocation score of 20% receives 20% of the award, etc. Step 445 may include reporting the respective award allocation to each of the team members.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, user input defining parameters of a project;
receiving, by the processor set, opt-in input from team members defined in the parameters of the project;
retrieving, by the processor set and from electronic data sources, data that corresponds to performance of tasks of the project by each of the team members;
generating, by the processor set and based on the retrieved data, a respective contribution score of each of the team members;
generating, by the processor set and based on the respective contribution scores of each of the team members, a respective allocation score of each of the team members;
allocating, by the processor set, an award to the team members based on the respective allocation scores of each of the team members.

2. The method of claim 1, wherein the contribution score of a respective one of the team members is based on:
quantity of contributions to the project by the respective one of the team members; and
quality of contributions to the project by the respective one of the team members.

3. The method of claim 2, wherein the quantity of work is determined based on an amount of content created by the respective one of the team members using content creating applications.

4. The method of claim 2, wherein the quality of work is determined based on determined sentiment of communications corresponding to the respective one of the team member's performance on the project.

5. The method of claim 4, further comprising determining the sentiment of the communications by analyzing the communications using natural language processing.

6. The method of claim 1, wherein the parameters define:
the team members;
the electronic data sources from which the data is obtained; and
scoring rules used for determining the respective contribution scores of each of the team members.

7. The method of claim 6, wherein the scoring rules comprise plural scoring rules and respective weighting values for each of the plural scoring rules.

8. The method of claim 7, wherein one or more of the respective weighting values is based on a role of a stakeholder.

9. The method of claim 6, wherein the electronic data sources include:
one or more local software applications;
one or more mail servers;
one or more conferencing servers;
one or more social collaboration servers;
one or more cloud software applications; and
one or more telephony application servers.

10. The method of claim 1, further comprising generating a respective scoring and allocation report for each of the team members, wherein the scoring and allocation report for one of the team members includes:
the contribution score of the team member; and
the allocation score of the team member.

11. The method of claim 10, further comprising:
receiving additional information from one of the team members;
regenerating the respective contribution score of each of the team members based on the obtained data and the additional information; and
regenerating the respective allocation score of each of the team members based on the regenerated contribution scores of each of the team members.

12. A computer program product comprising one or more computer readable storage media having program instructions collectively stored on the one or more computer readable storage media, the program instructions executable to:
receive user input defining parameters of a project;
receive opt-in input from team members defined in the parameters of the project;
retrieve, from electronic data sources defined in the parameters of the project, data that corresponds to performance of tasks of the project by each of the team members;
generate, based on the retrieved data, a respective contribution score of each of the team members;
generate, based on the respective contribution scores of each of the team members, a respective allocation score of each of the team members;
allocate an award to the team members based on the respective allocation scores of each of the team members.

13. The computer program product of claim 12, wherein the contribution score of a respective one of the team members is based on:
quantity of contributions to the project by the respective one of the team members; and
quality of contributions to the project by the respective one of the team members.

14. The computer program product of claim 13, wherein the quantity of work is determined based on an amount of content created by the respective one of the team members using content creating applications.

15. The computer program product of claim 13, wherein the quality of work is determined based on determined sentiment of communications corresponding to the respective one of the team member's performance on the project.

16. A system comprising:
a processor set, one or more computer readable storage media, and program instructions collectively stored on the one or more computer readable storage media, the program instructions executable to:
receive user input defining parameters of a project;
receive opt-in input from team members defined in the parameters of the project;
retrieve, from electronic data sources, data that corresponds to performance of tasks of the project by each of the team members;
generate, based on the retrieved data, a respective contribution score of each of the team members, wherein the contribution score of a respective one of the team members is based on quantity of contributions to the project by the respective one of the team members and quality of contributions to the project by the respective one of the team members;
generate, based on the respective contribution scores of each of the team members, a respective allocation score of each of the team members;
allocate an award to the team members based on the respective allocation scores of each of the team members.

17. The system of claim 16, wherein the quantity of work is determined based on an amount of content created by the respective one of the team members using content creating applications.

18. The system of claim 16, wherein the quality of work is determined based on determined sentiment of communications corresponding to the respective one of the team member's performance on the project.

19. The system of claim 18, wherein the program instructions executable to determine the sentiment of the communications by analyzing the communications using natural language processing.

20. The system of claim 16, wherein the parameters define:
the team members;
the electronic data sources from which the data is obtained; and
scoring rules used for determining the respective contribution scores of each of the team members.
